(19) United States
(12) Patent Application Publication
(10) Pub. No.: US 2004/0242837 A1
(43) Pub. Date: Dec. 2, 2004

(54) Rosin modified phenolic resin, gel varnish, printing ink, and method for producing rosin modified phenolic resin

(75) Inventors: Hiroshi Toyoda, Koshigaya-shi (JP); Satoru Yaguchi, Kitasouma-gun (JP)

Correspondence Address: SUGHRUE MION, PLLC, 2100 PENNSYLVANIA AVENUE, N.W., SUITE 800, WASHINGTON, DC, 20037, US

(73) Assignee: HARIMA CHEMICALS, INC.

(21) Appl. No.: 10/846,605

(22) Filed: May 17, 2004

(30) Foreign Application Priority Data
May 27, 2003 (JP) 2003-149741

(51) Int. Cl. C08G 8/04; C08G 8/32; C08G 14/04; C08G 8/34

(52) U.S. Cl. 528/158.5

(57) ABSTRACT

The present invention provides a rosin modified phenolic resin obtained by reacting a rosin, a phenol-formaldehyde initial condensate and a polyhydric alcohol, wherein the phenol-formaldehyde initial condensate is obtained by reacting phenols with formaldehyde in an ester of an animal and vegetable oil fatty acid and a monoalcohol and the proportion of the ester is from 5 to 200% by weight based on the total amount of the phenols and formaldehyde charged, a gel varnish and a printing ink, which contain the same, and a method for producing a rosin modified phenolic resin.

Priority is claimed to Japanese Patent Application No.2003-149741 filed on May 27, 2003, the disclosure of which is incorporated by reference in its entirety.

### BACKGROUND OF THE INVENTION

1. Field of the Invention

The present invention relates to a rosin modified phenolic resin, a gel varnish, a printing ink, and a method for producing a rosin modified phenolic resin and, more particularly, to a rosin modified phenolic resin for offset printing ink, which is environmentally friendly because it contains no or a reduced amount of a volatile organic solvent, and also has excellent printability and excellent economical efficiency, a gel varnish, a printing ink, and a method for producing a rosin modified phenolic resin.

2. Description of Related Art

With the increase of understanding of environmental problems in offset printing, a trial of reducing toxicity of raw materials used at present or replacing the raw materials by raw material with less toxicity has recently been made. For example, an aromatic component has been removed from volatile organic solvents such as mineral oil, which have conventionally been used as raw materials, and also there has been developed a non-VOC (Volatile Organic Compound) or VOC-less offset printing ink wherein a volatile organic solvent is replaced by an animal and vegetable oil or a fatty acid monoester originating from the animal and vegetable oil. However, only by replacing the volatile organic solvent by the fatty acid monoester originating from the animal and vegetable oil, drying properties of the ink drastically deteriorate, and thus causing problems such as deposition of the ink on the back surface of a paper and blocking upon stacking of printed matters.

With the increase of the speed of a printing press for the purpose of improving productivity of printed matters, inks suited for high speed printing have recently been developed. In such a high speed printing technique, non-VOC or VOC-less offset printing inks, wherein a volatile organic solvent is replaced by an animal and vegetable oil or a fatty acid monoester originating from the animal and vegetable oil, are effective for wood free papers and newspapers which have porosity and are easy to penetrate. However, good balance between gloss and drying properties can not be obtained for coat papers and art papers as main matters to be printed, and desired printing quality can not be obtained. It is impossible to satisfy printing quality required by the market if the volatile organic solvent is not used in combination in case of these printing papers.

As shown in the following patent publications, there have been made various trials of using an animal and vegetable oil or fatty acid monoester originating from the animal and vegetable oil in an offset printing ink in place of the volatile organic solvent.

Japanese Unexamined Patent Publication No. 5-112745 discloses a trial of using a fatty acid monoester comprising a fatty acid having 5 to 21 carbon atoms and a monoalcohol having 1 to 4 carbon atoms as a solvent for lithographic ink or letterpress ink.

Japanese Unexamined Patent Publication No. 6-93220 discloses a printing ink containing an aliphatic compound having 18 to 50 carbon atoms having one or more unsaturated groups, such as unsaturated fatty acid ester in a resin varnish.

However, printing inks (non-VOC offset printing inks, or VOC-less offset printing inks containing a prescribed amount of a volatile mineral oil) disclosed in the above respective publications cause drastic deterioration of ink drying properties, especially for coat papers and art papers, due to its poor permeability of the solvent into the paper or vaporization of the solvent, as compared with conventional offset printing inks, and thus problems such as long setting time, deposition on the back surface of the paper and blocking have not been solved. In case of the above printing inks, there arise problems that misting is likely to occur and emulsifiability resistance is poor.

### SUMMARY OF THE INVENTION

An advantage of the present invention is to provide a rosin modified phenolic resin which contains an animal and vegetable oil component as the solvent, and also gives a non-VOC or VOC-less printing ink excellent in gloss, drying properties, emulsifiability resistance and misting resistance when printed on coat papers and art papers, a gel varnish, a printing ink, and a method for producing a rosin modified phenolic resin.

The present inventors have intensively studied so as to solve the problems described above and found such a new fact that, when using a rosin modified phenolic resin produced by using, as a raw material, a phenol-formaldehyde initial condensate, which is obtained by reacting phenols with formaldehyde in an ester of an animal and vegetable fatty acid and a monoalcohol, the proportion of the ester being within a predetermined range based on the total amount of the phenols and formaldehyde charged, there can be obtained a non-VOC or VOC-less offset printing ink wherein all or portion of a volatile solvent is replaced by a fatty acid monoester originating from an animal and vegetable oil, which is excellent in gloss, drying properties, emulsifiability resistance and misting resistance, even when printed on coat papers and art papers. Thus, the present invention has been completed.

The rosin modified phenolic resin, the gel varnish, the printing ink, and the method for producing a rosin modified phenolic resin of the present invention have the following constitutions.

(1) A rosin modified phenolic resin obtained by reacting a rosin, a phenol-formaldehyde initial condensate and a polyhydric alcohol, wherein the phenol-formaldehyde initial condensate is obtained by reacting phenols with formaldehyde in an ester of an animal and vegetable oil fatty acid and a monoalcohol and the proportion of the ester is from 5 to 200% by weight based on the total amount of the phenols and formaldehyde charged.

(2) The rosin modified phenolic resin described in (1), wherein the rosin is modified with an α,β-ethylenically unsaturated dibasic acid or an anhydride thereof.

(3) The rosin modified phenolic resin described in (1), wherein the monoalcohol is a compound having 1 to 8 carbon atoms.

(4) The rosin modified phenolic resin described in (1), wherein the animal and vegetable oil fatty acid is a fatty acid whose aliphatic hydrocarbon residue excluding a carboxyl group has 5 to 21 carbon atoms.

(5) The rosin modified phenolic resin described in (1), wherein the phenol-formaldehyde initial condensate is obtained by reacting phenols with formaldehyde in an ester of the animal and vegetable oil fatty acid, the rosin and the monoalcohol.

(6) The rosin modified phenolic resin described in (5), wherein tall oil is used as a mixture of the animal and vegetable oil fatty acid and the rosin, and the phenol-formaldehyde initial condensate is obtained by reacting phenols with formaldehyde in an ester of the tall oil and the monoalcohol.

(7) The rosin modified phenolic resin described in (1), which is modified with a petroleum resin.

(8) A gel varnish comprising the rosin modified phenolic resin described in (1), an animal and vegetable oil component, and a gelling agent.

(9) A printing ink comprising the gel varnish described in (8).

(10) A method for producing a rosin modified phenolic resin, which comprises reacting a rosin with a phenol-formaldehyde initial condensate and then esterifying the reaction product with a polyhydric alcohol to give the rosin modified phenolic resin, the phenol-formaldehyde initial condensate being obtained by reacting phenols with formaldehyde in an ester of an animal and vegetable oil fatty acid and a monoalcohol or an ester of tall oil and a monoalcohol.

(11) The method for producing a rosin modified phenolic resin described in (10), wherein the temperature of the reaction between phenols and formaldehyde is from 30 to 200° C.

According to the rosin modified phenolic resin, the gel varnish, the printing ink, and the method for producing a rosin modified phenolic resin of the present invention, there is exerted such the effect that a resin having excellent printability such as gloss, drying properties, emulsifiability resistance, misting resistance or the like can be obtained even if the animal and vegetable oil component is used as the solvent in place of the volatile organic solvent. Because of excellent printability, when using as a sheet-fed ink, flow properties and gloss are improved and setting time decreases, and also stacking stability is improved, regardless of printing on coat papers or art papers. When using as a web offset ink and a news ink, the ink is suited for high speed printing because of its quick drying property, and also shows less misting, less variation in physical properties with a lapse of time and high operation efficiency.

The objects and advantages of the present invention will become apparent from the following detailed description.

### DESCRIPTION OF PREFERRED EMBODIMENTS

One embodiment of the present invention will be described in detail.

<Rosin Modified Phenolic Resin>

The rosin modified phenolic resin of the present invention is obtained by reacting a rosin with a phenol-formaldehyde initial condensate (resol resin) and esterifying the reaction product with a polyhydric alcohol and it is particularly important that the phenol-formaldehyde initial condensate is a phenol-formaldehyde initial condensate obtained by condensing phenols with formaldehyde in an ester of animal and vegetable oil fatty acid and a monoalcohol or an ester of tall oil and a monoalcohol in the presence of an alkali catalyst.

Examples of the rosin include gum rosin, wood rosin, tall oil rosin, distilled rosin, polymerized rosin, disproportionated rosin, and hydrogenated rosin. The disproportionated rosin and hydrogenated rosin can not be used because they do not react with the phenol formaldehyde initial condensate, but can be used in combination with the other rosin.

Examples of the animal and vegetable oil fatty acid include caproic acid, caprylic acid, capric acid, isooctanoic acid, isononanoic acid, lauric acid, myristic acid, palmitic acid, palmitoleic acid, stearic acid, isostearic acid, oleic acid, linoleic acid, linolenic acid, eleostearic acid, arachdic acid, arachidonic acid, behenic acid, and erucic acid, each containing an alkyl residue excluding a carboxyl group having 5 to 21 carbon atoms. These animal and vegetable oil fatty acids are originated from animal and vegetable oils such as coconut oil, palm oil, rapeseed oil, soybean oil, hydrogenated soybean oil, linseed oil, tung oil, beef tallow, and fish oil.

These animal and vegetable oil fatty acids can be used alone, and preferably used in the form of a mixture such as coconut oil fatty acid, palm oil fatty acid, rapeseed oil fatty acid, or soybean oil fatty acid in view of economy. Also tall oil fatty acid and monomer acid can be preferably used. The monomer acid is by-product obtained when a polymerized fatty acid is produced by polymerizing an unsaturated fatty acid such as tall oil fatty acid, and contains a fatty acid having a branched structure, in addition to stearic acid, oleic acid or the like.

In the present invention, the animal and vegetable oil fatty acid may further contain a rosin. In this case, a mixture of the animal and vegetable oil fatty and rosin may be used and tall oil is more preferably used as the mixture of the animal and vegetable oil fatty and rosin. When using tall oil, the phenol-formaldehyde initial condensate is obtained by reacting phenols with formaldehyde in an ester of the tall oil and monoalcohol. The tall oil is a mixture of a tall oil fatty acid and a rosin. In the step of purifying the tall oil, a mixing ratio of the fatty acid to the rosin can be optionally adjusted. Therefore, it is economical to use the tall oil as a raw material in the production of the rosin modified phenolic resin of the present invention.

Examples of the monoalcohol include alcohols whose alkyl group has 1 to 8 carbon atoms, for example, methanol, ethanol, propanol, isopropanol, butanol, isobutanol, amyl alcohol, isoamyl alcohol, hexyl alcohol, heptyl alcohol, octyl alcohol, and 2-ethylhexyl alcohol.

The ester of the animal and vegetable oil fatty acid and the monoalcohol can be obtained by a known method such as direct esterification reaction between the animal and vegetable oil fatty acid and the monoalcohol, transesterification reaction between the animal and vegetable oil and the monoalcohol or the like.

As the phenols, there can be used any aromatic compounds having a phenolic hydroxyl group, for example, phenol, p-cresol, p-tertiary butylphenol, p-amylphenol, p-octylphenol, p-nonylphenol, p-dodecylphenol, and bisphenol A. Among these compounds, bisphenols and phenol, and alkylphenol compounds substituted with an alkyl group having 4 or less carbon atoms at the para-position are preferable. As the formaldehyde, aqueous paraformaldehyde and formalin solutions are used.

Examples of the polyhydric alcohol include glycerin, trimethylolethane, trimethylolpropane, diethylene glycol, triethylene glycol, 1,6-hexanediol, trimethylolpropane, pentaerythritol, dipentaerythritol, and sorbitol.

As described above, the phenol-formaldehyde initial condensate is obtained by reacting phenols with formaldehyde in an ester of an animal and vegetable oil fatty acid and a monoalcohol or an ester of tall oil and a monoalcohol.

The proportion of these esters may be within a range from 5 to 200% by weight, and preferably from 20 to 100% by weight, based on the total amount of the phenols and formaldehyde charged. When the proportion of these esters is small, the resulting rosin modified phenolic resin has high viscosity and a large amount of a volatile solvent for adjusting to the viscosity suited for printing, or a fatty acid monoester must be used, and thus printing quality deteriorates. On the other hand, when the proportion of these esters is large, a resol resin does not react and the resulting rosin modified phenolic resin has low molecular weight and viscosity, and thus balance of a vehicle can not be adjusted in the preparation of a printing ink and the resulting printing ink does not satisfy the required performances.

The temperature of the reaction between phenols and formaldehyde is from 30 to 200° C., and preferably from 60 to 100° C. In this reaction, a phenol-formaldehyde initial condensate (resol type phenol resin), which combines with the rosin ester resin to form a chroman ring, may be synthesized by using a catalyst so that the resulting phenol-formaldehyde initial condensate is mainly composed of a bi- to hexanuclear phenol compound. As the catalyst, an alkali catalyst such as calcium hydroxide, magnesium hydroxide, amines, aqueous ammonia solution or the like is preferably used in the proportion of 0.1 to 3% by weight based on the total amount of phenol.

The phenol-formaldehyde initial condensate thus obtained is added in the amount within a range from 10 to 200 parts, and preferably from 30 to 100 parts, based on 100 parts of the rosin using, as the solvent, an ester of an animal and vegetable oil fatty acid and a monoalcohol or an ester of tall oil and a monoalcohol, and thus the addition reaction of phenol to the rosin is conducted. The reaction temperature during the addition reaction is from 60 to 280° C., and preferably from 120 to 260° C.

The rosin modified phenolic resin of the present invention can be obtained by adding the polyhydric alcohol to the reaction product in the amount within a range from 0.8 to 1.5, and preferably from 1.0 to 1.2, in terms of an OH equivalent based on an acid value of entire carboxylic acid and ester, and allowing to proceed the esterification reaction at the temperature of 240° C. or higher, and preferably from 260 to 280° C. The amount of the polyhydric alcohol to be added has a close relation with weight average molecular weight, viscosity and solubility of the resulting resin varnish as well as emulsifiability after forming into an ink. When the amount of the polyhydric alcohol is more than the above range, desired performances may not be obtained. On the other hand, when the amount is less than the above range, the reaction may require a long time because the reaction rate decreases.

In the present invention, the rosin to be reacted with the phenol-formaldehyde initial condensate may be previously modified with an α,β-ethylenically unsaturated dibasic acid or an anhydride thereof by heating at 180 to 240° C. Consequently, it is made possible to more improve drying properties of the printing ink when using the rosin modified phenolic resin as a printing ink. Examples of the α,β-ethylenically unsaturated dibasic acid and anhydride thereof include fumaric acid, maleic acid and maleic anhydride. In case of esterifying the rosin, the other dibasic acid or an anhydride thereof can be used in combination, and examples of the other dibasic acid or anhydride thereof include adipic acid, sebacic acid, azelaic acid, itaconic acid, itaconic anhydride, phthalic anhydride, isophthalic acid, terephthalic acid, trimellitic anhydride, pyromellitic acid, dimer acid, and trimer acid.

The rosin modified phenolic resin may be modified with a petroleum resin. When using the rosin modified phenolic resin modified with the petroleum resin in the printing ink, hydrophobicity of the resulting printing ink is improved and emulsifiability resistance is also improved. As the petroleum resin, those having an unsaturated bond in the molecule, for example, petroleum resins classified into the followings based on a structure having a carbon-carbon double bond can be used. That is, the petroleum resin can be classified into indene, coumarone, cyclopentadiene and dicyclopentadiene resins each having an unsaturated cyclic structure; pentene and pentadiene resins each having an unsaturated hydrocarbon chain; and vinyltoluene and α-methylstyrene resins each having a carbon-carbon double bond and an unsaturated hydrocarbon chain substitiuted with a conjugated aromatic ring. The petroleum resin may be added before or after charging the polyhydric alcohol, and then the reaction is conducted by heating to the temperature within a range from 100 to 280° C. In the present invention, there can be used the petroleum resin which is previously modified with an α,β-ethylenically unsaturated dibasic acid or an anhydride.

The rosin modified phenolic resin thus obtained preferably has a weight average molecular weight within a range from 10,000 to 200,000, and more preferably from 40,000 to 150,000. When the weight average molecular weight is less than 10,000, drying properties and misting resistance may deteriorate. On the other hand, when the weight average molecular weight exceeds 200,000, gloss may deteriorate. To adjust the weight average molecular weight within the above range, there can be used conventionally known methods such as modification of the constituent components of the resin, modification of the composition ratio, and modification of production conditions.

<Gel Varnish>

The rosin modified phenolic resin of the present invention is obtained in the form of a solid or a viscous liquid according to the kind and amount of raw materials as well as production conditions. A gel varnish for offset printing ink having desired physical properties can be obtained by adding an animal and vegetable oil component and a gelling agent to the rosin modified phenolic resin and gelling the rosin modified phenolic resin. Examples of the gelling agent include aluminum compounds such as aluminum chelete and aluminum soaps.

Without isolating the rosin modified phenolic resin, the reaction product obtained in the production of the rosin modified phenolic resin can be used in the production of the gel varnish. For example, the gel varnish can be obtained by adding the reaction product obtained above to a solution, which is previously prepared by adding an animal and vegetable oil component and a gelling agent and uniformly mixing them, performing the gelling reaction at 120 to 220° C., and adjusting the viscosity. As described above, by continuously performing from the production of the rosin modified phenolic resin to the preparation of the gel varnish, it becomes unnecessary to perform solidification so as to isolate the resin and redissolution, and thus wastes and environmental burden can be reduced and energy required for the production can be remarkably saved.

A portion or all of the animal and vegetable oil component may be a fatty acid monoester. Examples of the fatty acid monoester include methyl laurate, butyl laurate, methyl myristate, butyl myristate, methyl palmitate, butyl palmitate, methyl stearate, butyl stearate, octyl stearate, methyl oleate, butyl oleate, octyl oleate, butyl linoleate, and octyl linoleate, and mixtures thereof. Furthermore, these fatty acids or mixtures thereof may be esterified with alcohols such as methyl alcohol, butyl alcohol, and octyl alcohol. As the animal and vegetable oil component, for example, there can be used animal and vegetable oils such as cotton seed oil, soybean oil, safflower oil, dehydrated castor oil, linseed oil, tung oil, cuttlefish oil, and sardine oil. These animal and vegetable oils may be added, together with the fatty acid monoester. Together with the animal and vegetable oil component, a small amount of volatile ink solvents such as “Solvent AF6 (trade name).” and “Solvent AF7 (trade name)” (manufactured by Nippon Oil Corp.) may be added.

The gel varnish of the present invention contains 35 to 70% by weight, preferably 40 to 60% by weight of the rosin modified phenolic resin. In case of using for web offset ink, the content of the animal and vegetable oil is about 5 to 8% by weight of the gel varnish. In case of using for sheet-fed ink, the content is preferably about 15 to 20% by weight of the gel varnish. The remaining components of the gel varnish are composed of the fatty acid monoester and gelling agent required for adjusting viscosity and elasticity of the printing ink.

<Printing Ink>

Offset printing inks such as sheet-fed ink and web offset ink can be obtained by dispersing yellow, crimson, indigo blue and jet-black pigments in the gel varnish obtained above, optionally adding compounds such as wear resistance modifiers, ink dryers, drying inhibitors, and adjusting the viscosity to proper viscosity. The content of the gel varnish in the printing ink is preferably from about 60 to 90% by weight. In case of adjusting viscosity and elasticity of the printing ink, volatile ink solvents such as “Solvent AF6 (trade name)” and “Solvent AF7 (trade name)” may be added in the proportion of 3% or less.

The printing ink of the present invention can also be used as news ink and letterpress ink. Furthermore, it can also be used as gravure ink and flexographic ink by dissolving the resin of the present invention in an aliphatic or alicyclic solvent having a boiling point of 140° C. or lower at normal pressure.

Since the rosin modified phenolic resin of the present invention can be formed into a gel varnish without removing in the form of solid, the product may be in the form of solid or liquid. Because of excellent printability, when using as a sheet-fed ink, flow properties and gloss are improved and setting time decreases, and also stacking stability is improved, regardless of printing on coat papers or art papers. When using as a web offset ink and a news ink, the ink is suited for high speed printing because of its quick drying property, and also shows less misting, less variation in physical properties with a lapse of time and high operation efficiency. When using as a waterless ink, a cohesive force of the ink is obtained and ground contamination can be prevented. The printing ink obtained by the present invention can be used not only as an offset printing ink, but also as inks for screen printing and letterpress printing because of less content of the decomposition product and the nonuniform gelling component in the rosin modified phenolic resin.

### EXAMPLES

The resin for printing ink and the method for producing the same of the present invention as well as printing properties of the ink obtained by using the resin for printing ink of the present invention will be described in detail by way of specific examples. It is understood, however, that the examples are for the purpose of illustration and the invention is not to be regarded as limited to any of the specific materials or condition therein. In the following specific examples, parts are by weight unless otherwise specified.

<Synthesis of Phenol Formaldehyde Initial Condensate>

In a reaction vessel, 200 parts of SE-100-1 (soybean oil fatty acid methyl ester: manufactured by Nikka Chemical Co., Ltd.), 568 parts of para-tertiary butylphenol, 142 parts by of bisphenol A and 316 parts of paraformaldehyde were charged and 14 parts of sodium hydroxide was added, and then the mixture was heated to 90° C. and maintained at the same temperature for 5 hours to obtain 1240 parts (resol resin solid content: 80.6%) of a phenol formaldehyde initial condensate (hereinafter referred to as a resol resin (1)).

<Synthesis of Rosin Modified Phenolic Resin>

### Example 1

After dissolving 700 parts of HARTALL rosin, WW (manufactured by Harima Chemicals, Inc.) in a reaction vessel, 370 parts of the above resol resin (1) was added dropwise at 200° C. over 3 hours and 82 parts of pentaerythritol was added. The mixture was heated to 270° C. and esterified until an acid value reaches 20, a rosin modified phenolic resin thus obtained was taken out. Properties of the resulting rosin modified phenolic resin are shown in Table 1.

### Example 2

The same operation as in Example 1 was conducted, except that 35 parts of maleic anhydride was added to 700 parts of HARTALL rosin WW and maleination was conducted at 200° C. for one hour, and a rosin modified phenolic resin was taken out. Properties of the resulting rosin modified phenolic resin are shown in Table 1.

### Example 3

The same operation as in Example 1 was conducted, except that 35 parts of maleic anhydride was added to a component prepared by dissolving 700 parts of HARTALL rosin WW and 140 parts of MARUKAREZ S119 (petroleum resin, manufactured by Maruzen Petrochemical Co., Ltd.) artd maleination was conducted at 200° C. for one hour, and a rosin modified phenolic resin was taken out. Properties of the resulting rosin modified phenolic resin are shown in Table 1.

### Example 4

The same operation as in Example 1 was conducted, except that 370 parts of a resol resin (2), which was synthesized by using 200 parts of SR-30IB (isobutyl ester of a tall oil fraction comprising 70% by weight of a tall oil fatty acid and 30% by weight of a rosin: manufactured by Harima Chemicals, Inc.) in place of SE-100-1 used in the synthesis of the resol resin (1), was added in place of the resol resin (1), and a rosin modified phenolic resin was taken out. Properties of the resulting rosin modified phenolic resin are shown in Table 1.

### Example 5

The same operation as in Example 1 was conducted, except that 612 parts of a resol resin (3) (resol resin solid content: 49.0%), which was synthesized by adding 1000 parts of SE-100-1 in the synthesis of the resol resin (1), was added, and a rosin modified phenolic resin was taken out. Properties of the resulting rosin modified phenolic resin are shown in Table 1.

### Comparative Example 1

As the rosin modified phenolic resin, HARIPHENOL ERP40 manufactured by Harima Chemicals, Inc. was used. Properties of the resulting rosin modified phenolic resin are shown in Table 1. HARIPHENOL ERP-40 is obtained by reacting a rosin, a phenol formaldehyde initial condensate and glycerin.

### Comparative Example 2

As the rosin modified phenolic resin, HARIPHENOL P-637 manufactured by Harima Chemicals, Inc. was used. Properties of the resulting rosin modified phenolic resin are shown in Table 1. HARIPHENOL P-637 is obtained by reacting a rosin, a phenol formaldehyde initial condensate and pentaerythritol.

### Comparative Example 3

The same operation as in Example 1 was conducted, except that 942 parts of a resol resin (4) (resol resin solid content: 31.8%), which was synthesized by adding 2100 parts of SE-100-1 used in the synthesis of the resol resin (1), was added, and a rosin modified phenolic resin was taken out. Properties of the resulting rosin modified phenolic resin are shown in Table 1.

### Comparative Example 4

A trial of synthesizing the rosin modified phenolic resin was made by the same operation as in Example 1, except that 320 parts of a resol resin (5) (resol resin solid content: 93.9%), which was synthesized by adding 20 parts of SE-100-1 used in the synthesis of the resol resin (1), was added. However, it became impossible to stir the mixture because the molecular weight of the resin increased excessively during the reaction, and thus the reaction was terminated.

Softening point, acid value, viscosity (linseed oil viscosity), solubility in solvent (Solvent AF6 dissolution cloud point) and weight average molecular weight of the respective rosin modified phenolic resins thus obtained were evaluated. The viscosity, solubility in solvent and weight average molecular weight were evaluated by the following procedures. The results are shown in Table 1. Although the softening point and viscosity of the resins of Examples 1 to 5 are considerably low as compared with the resins of Comparative Examples, the molecular weight bears comparison with the resins of Comparative Examples.

Linseed oil viscosity (Gardner bubble type viscosity): A mixture was obtained by mixing linseed oil and a rosin modified phenolic resin in a weight ratio of 2:1 and dissolving with heating and the time that is required for bubbles to reach a standard line was measured by a Gardner bubble type viscometer manufactured by BYK Gardner Co.

Solubility in solvent: The cloud point temperature of a solution (resin/solvent AF6=1/10) was measured by a Chemotronic cloud point meter (manufactured by Novocontrol Co.).

Weight average molecular weight: The molecular weight relative to polystyrene

TABLE 1
standards was measured by gel permeation chromatography (GPC).

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| Softening point (° C.) | 136 | 152 | 148 | 145 | half- | 160 | 170 | liquid |
| | | | | | solid | | | |
| Acid value (mgKOH/g) | 19.9 | 18.6 | 17.1 | 19.8 | 13.8 | 17.2 | 23.2 | 12.2 |
| Linseed oil viscosity (sec.) | 144 | 172 | 156 | 127 | 43 | 400 | 300 | 13 |
| Solubility in solvent (° C.) | 162 | 200< | 187 | 132 | 168 | 140 | 38 | 87 |
| Weight average molecular | 70,000 | 130,000 | 150,000 | 70,000 | 40,000 | 200,000 | 100,000 | 8,000 |
| weight | | | | | | | | |

<Production of Gel Varnish>

### Examples 1 to 5 and Comparative Examples 1 and 3

Each of the rosin modified phenolic resins thus obtained, linseed oil and a soybean oil fatty acid isobutyl ester “SE-120-IB” (trade name)” were charged in a reaction vessel in each amount shown in Table 2, heated while blowing a nitrogen gas into the reaction vessel, and then maintained at 200° C. while stirring for 30 minutes to obtain a varnish. The resulting varnish was cooled to 100° C. and a gelling agent was added in the amount shown in Table 2 so as to achieve proper viscosity suited for printing ink, and then the mixture was heated again to 200° C. and maintained for one hour to obtain a gel varnish for printing ink. As the gelling agent, those obtained by diluting 70 parts of Chelope EP-12 (manufactured by Hope Chemical Co., Ltd.) with 30 parts of a soybean oil fatty acid isobutyl ester SE-120-IB (manufactured by Nikka Chemical Co., Ltd.) were used.

### Comparative Example 2

In the same manner as in Example 1, except that Solvent AF6 (manufactured by Nippon Oil Corp.) was used in the amount shown in Table 2 in place of the soybean oil fatty acid isobutyl ester (SE-120-IB (trade name)), a gel varnish was obtained.

<Production of Printing Ink>

In 60 parts by weight of the varnish thus obtained, 18 parts by weight of Cyanine Blue (manufactured by DAINIPPON INK & CHEMICALS Co., Ltd.) as an indigo blue pigment was dispersed by a three-roll mill and the gel varnish and SE-120-IB were added so as to adjust tack to 9 to 10. Then Solvent AF6 was optionally added in the amount shown in Table 2 only in Comparative Example 2, and the mixture was uniformly mixed with 0.5 parts by weight of a 6% manganese naphthenate solution (Harima Chemicals, Inc.) to obtain a printing ink.

TABLE 2
unit: parts by weight

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| Rosin modified phenolic | 45.0 | 44.0 | 45.0 | 47.0 | 54.0 | 40.0 | 40.0 | 75.0 |
| resin | | | | | | | | |
| Linseed oil | 20.0 | 20.0 | 20.0 | 20.0 | 20.0 | 20.0 | 20.0 | 20.0 |
| Soybean oil fatty acid | 35.0 | 36.0 | 35.0 | 33.0 | 26.0 | 40.0 | | 5.0 |
| isobutyl ester | | | | | | | | |
| Solvent AF6 | | | | | | | 40.0 | |
| Gelling agent | 0.4 | 0.4 | 0.6 | 0.6 | 1.0 | 0.4 | 0.8 | 2.4 |
| Total | 100.4 | 100.4 | 100.6 | 100.6 | 101.0 | 100.4 | 100.8 | 102.4 |
| Gel varnish | 78.0 | 77.0 | 78.0 | 79.0 | 82.0 | 70.0 | 70.0 | Since the |
| Indigo blue pigment | 18.0 | 18.0 | 18.0 | 18.0 | 18.0 | 18.0 | 18.0 | viscosity |
| Soybean oil fatty acid | 4.0 | 5.0 | 4.0 | 3.0 | | 12.0 | | was low, an |
| isobutyl ester | | | | | | | | ink could not |
| Solvent AF6 | | | | | | | 12.0 | be obtained. |
| Manganese naphthenate | 0.5 | 0.5 | 0.5 | 0.5 | 0.5 | 0.5 | 0.5 | |
| solution | | | | | | | | |
| Total | 100.5 | 100.5 | 100.5 | 100.5 | 100.5 | 100.5 | 100.5 | |

Physical properties of the resulting printing ink are shown in Table 3. Physical properties were evaluated by the following procedures.

Flow properties (flow: 60 second, m): Using Spread Meter manufactured by RIGO CO., Ltd., spread (diameter) of the ink was measured.

Gloss value: 0.3 cc of the ink was spread over an art paper by an entire surface roll of RI Tester (manufactured by Akira Seisakusho) and, after 24 hours, the gloss value was measured by a 60°-60° gloss meter.

Set: 0.1 cc of the ink was spread by 4-Cut Roll of RI Tester (manufactured by Akira Seisakusho) and a spread matter was cut and then laminated on another art paper to obtain a sample. The roll of RI Tester was used to measure the time (minutes) required until ink is not deposited on the art paper.

Drying properties on machine: 0.1 cc of the ink was spread over a parchment paper by 4-Cut Roll of RI Tester (manufactured by Akira Seisakusho) and; after laminating the parchment papers, the resulting sample was mounted to a Choyokai type drying tester and the drying time was compared under the conditions of 0.1 rpm.

Maximum emulsification amount: Using Lithotronic Emulsification Tester (manufactured by Novocontrol Co.), water was added to 25 g of the ink at 40° C. at a rate of 2 ml/min. and the moisture content upon saturation of the ink was measured (rotation number of Emulsification Tester: 1200 rpm).

Misting: Two cups of the ink on Inkometer (manufactured by Toyo Seiki Seisaku-Sho, Ltd.) and rotated at a roll temperature of 40° C. and 2000 rpm for 2 minutes. Then, the state of the ink scattered on a white paper placed under or front of the roll was visually observed. The following five-rating evaluation was conducted.

5: no misting

4: slight misting

3: some misting

2: considerable misting

1: severe misting

TABLE 3

| | | | | | | Comparative | Comparative |
|---|---|---|---|---|---|---|---|
| | Example 1 | Example 2 | Example 3 | Example 4 | Example 5 | Example 1 | Example 2 |
| Tack (400 rpm, 30° C.) | 9.2 | 9.1 | 9.3 | 9.8 | 9.2 | 9.3 | 9.2 |
| Flow property (60 sec., mm) | 32.0 | 31.4 | 31.6 | 32.0 | 32.0 | 31.0 | 31.8 |
| Gloss value | 71.2 | 69.3 | 70.0 | 74.0 | 69.5 | 63.7 | 67.2 |
| Set (min.) | 27 | 24 | 27 | 30 | 27 | 30 | 21 |
| Drying property on machine | 15< | 15< | 15< | 15< | 15< | 15< | 14 |
| (hr) | | | | | | | |
| Maximum emulsification | 65 | 65 | 50 | 65 | 65 | 75 | 65 |
| amount (%) | | | | | | | |
| Misting | 4 | 5 | 4 | 4 | 3 | 2 | 5 |

As is apparent from the results shown in Table 3, the sheet-fed inks obtained from the rosin modified phenolic resins of Examples 1 to 5 showed high gloss as compared with the sheet-fed ink obtained by using the rosin modified phenolic resin (conventional rosin modified phenolic resin) of Comparative Example 1 and replacing a volatile organic solvent by a fatty acid monoester originating from an animal and vegetable oil when formed into a gel varnish. The inks of Examples 1 to 5 were excellent in emulsifiability resistance because the maximum emulsification amount decreased by about 10% as compared with Comparative Example 1, and also showed improved misting resistance.

Furthermore, the sheet-fed inks obtained from the rosin modified phenolic resins of Examples 1 to 5 showed excellent or equivalent gloss, set, emulsifiability resistance and misting resistance in printing on an art paper as compared with the sheet-fed ink obtained by using the rosin modified phenolic resin of Comparative Example 2 and adding a conventionally used ink solvent made of a volatile organic solvent. Thus, it could been confirmed that the non-VOC or VOC-less offset printing ink containing the rosin modified phenolic resin of the present invention sufficiently meet the demand of the market to a conventional printing ink.

What is clamed is:

1. A rosin modified phenolic resin obtained by reacting a rosin, a phenol-formaldehyde initial condensate and a polyhydric alcohol, wherein the phenol-formaldehyde initial condensate is obtained by reacting phenols with formaldehyde, hyde in an ester of an animal and vegetable oil fatty acid and a monoalcohol and the proportion of the ester is from 5 to 200% by weight based on the total amount of the phenols and formaldehyde charged.

2. The rosin modified phenolic resin according to claim 1, wherein the rosin is modified with an α,β-ethylenically unsaturated dibasic acid or an anhydride thereof.

3. The rosin modified phenolic resin according to claim 1, wherein the monoalcohol is a compound having 1 to 8 carbon atoms.

4. The rosin modified phenolic resin according to claim 1, wherein the animal and vegetable oil fatty acid is a fatty acid whose aliphatic hydrocarbon residue excluding a carboxyl group has 5 to 21 carbon atoms.

5. The rosin modified phenolic resin according to claim 1, wherein the phenol-formaldehyde initial condensate is obtained by reacting phenols with formaldehyde in an ester of the animal and vegetable oil fatty acid, the rosin and the monoalcohol.

6. The rosin modified phenolic resin according to claim 5, wherein tall oil is used as a mixture of the animal and vegetable oil fatty acid and the rosin, and the phenol-formaldehyde initial condensate is obtained by reacting phenols with formaldehyde in an ester of the tall oil and the monoalcohol.

7. The rosin modified phenolic resin according to claim 1, which is modified with a petroleum resin.

8. A gel varnish comprising the rosin modified phenolic resin of claim 1, an animal and vegetable oil component, and a gelling agent.

9. A printing ink comprising the gel varnish of claim 8.

10. A method for producing a rosin modified phenolic resin, which comprises reacting a rosin with a phenol-formaldehyde initial condensate and then esterifying the reaction product with a polyhydric alcohol to give the rosin modified phenolic resin, wherein the phenol-formaldehyde initial condensate is obtained by reacting phenols with formaldehyde in an ester of an animal and vegetable oil fatty acid and a monoalcohol or an ester of tall oil and a monoalcohol.

11. The method for producing a rosin modified phenolic resin according to claim 10, wherein the temperature of the reaction between phenols and formaldehyde is from 30 to 200° C.
